(19) United States
(12) Patent Application Publication
(10) Pub. No.: US 2004/0130736 A1
(43) Pub. Date: Jul. 8, 2004

(54) Preview method of color processing on input images

(76) Inventor: Robin Lee, Hsinchu (TW)

Correspondence Address: BIRCH STEWART KOLASCH & BIRCH, PO BOX 747, FALLS CHURCH, VA, 22040-0747, US

(21) Appl. No.: 10/618,682

(22) Filed: Jul. 15, 2003

(30) Foreign Application Priority Data
Jan. 8, 2003 (TW) 92100331

(51) Int. Cl. H04N 1/56; H04N 1/387; H04N 1/407; H04N 1/409

(52) U.S. Cl. 358/1.9; 358/527; 358/538; 358/453; 358/3.27; 358/537; 358/452

(57) ABSTRACT

A preview method of color processing on input images is disclosed, which enabling users to select a block of a preview image in image processing software, to apply various image processing functions in a WYSIWYG way. The disclosed method saves time, and doesn't need repeated input or too many system resources.

### BACKGROUND OF THE INVENTION

1. Field of Invention

The invention is related to image processing in computers, especially to provide image process functions with preview images of original images in image processing software.

2. Related Art

With the decrease of the cost/performance ratio of digital image input devices (e.g., digital camera, scanner . . . ), digital image input devices are widely used. Hence, in addition to cost, convenience and operability of digital images, convenient devices are also important. In order to enable users to transfer digital images to computers conveniently and to process these images, general-purpose digital image input devices usually provide users with specific image processing software. This software enables them to preview original images and apply image processing functions to these images. If users are not satisfied with original images, this kind of software usually provides some image processing functions (e.g., color-adjustments, brightness, contrast, resolution . . . ) for users to adjust original images. However, all known image processing software separates the previews of original images and adjusted images. That is, when setting up the adjustment parameters, users cannot immediately view the results of adjustments. The results of adjustments will not show up until users confirm and execute the adjustments. Since users cannot view the results of adjustments immediately when setting up adjustment parameters, they must set up adjustment parameters and view the results of adjustments repeatedly until the results are satisfactory. This is inconvenient for users, so a suitable solution is required.

### SUMMARY OF THE INVENTION

This invention proposes a preview method for color processing on input images, enabling users to execute image-processing functions on arbitrarily selected blocks of preview images in image processing software. The results of adjustments are displayed in a “What You See is What You Get” (abbreviated as WYSIWYG) way.

The invention proposes a simpler and more efficient image processing method by combining the previews of images and the executions of image processing functions. In addition, by block selection technique, the method reduces the time of image processing, the time to display results and the repeated executions of image processing functions.

To achieve the mentioned goals, the proposed preview method of color processing on input images comprises the following steps. First, an original input image is read, and the first preview image is extracted and displayed. Then, image-processing functions are executed on the selected block. Finally, the image processing functions are executed on the original image, and the result image is displayed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 shows the main flowchart of the proposed preview method of color processing on input images.

FIG. 2 shows the flowchart of the block selection of the proposed preview method of color processing on input images.

FIG. 3 shows an example of reading an original image of the proposed preview method of color processing on input images.

FIG. 4 shows an example of the user interface of the proposed preview method of color processing on input images.

FIG. 5 shows an example of the selection of a selected block of the proposed preview method of color processing on input images.

FIG. 6 shows an example of the selection of a selected block of the proposed preview method of color processing on input images.

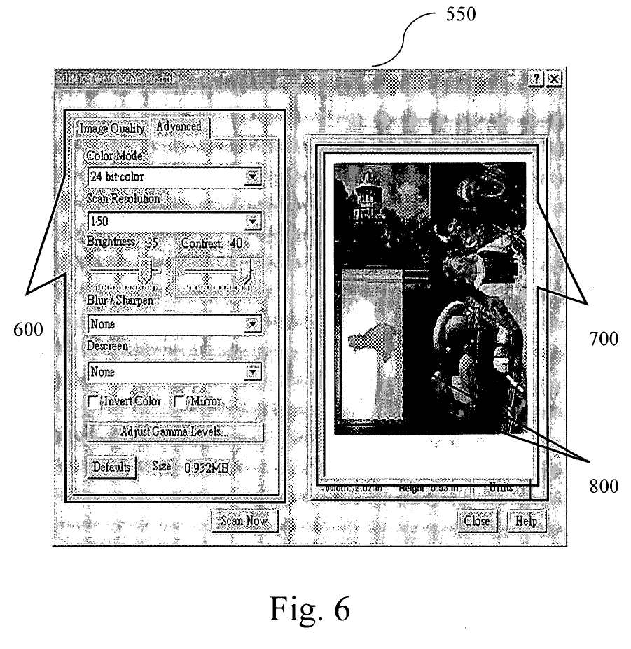

FIG. 7 shows an example of the selection of a selected block of the proposed preview method of color processing on input images.

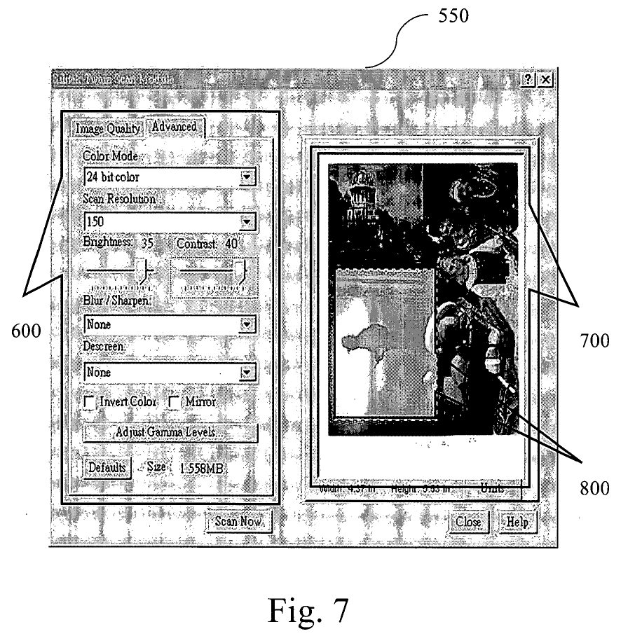

FIG. 8 shows an example of displaying the result image of the proposed preview method of color processing on input images.

### DETAILED DESCRIPTION OF THE INVENTION

The invention proposes a preview method of color processing on input images employed in image processing software. Users usually employ specific image processing software to transfer images from digital image input devices (e.g., scanner, digital camera, digital video camcorder . . . ) to computers. This kind of software also enables users to preview original images, apply image-processing functions to original images, and store processed images in computers. The proposed method enables users to execute image-processing functions on arbitrarily selected blocks of preview images in a WYSIWYG way.

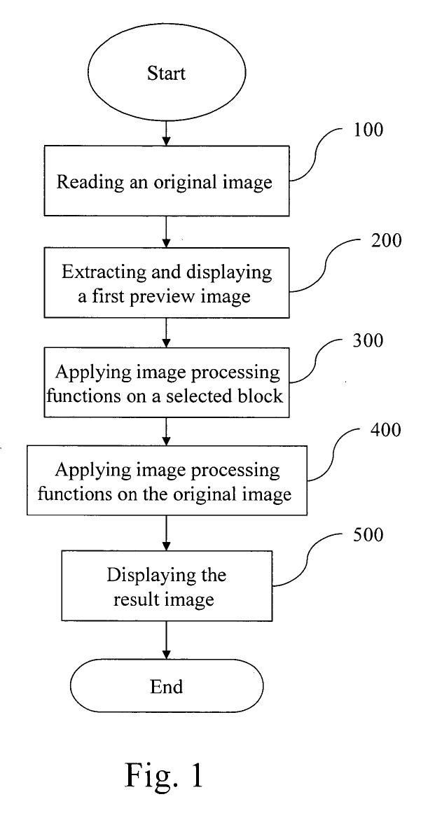

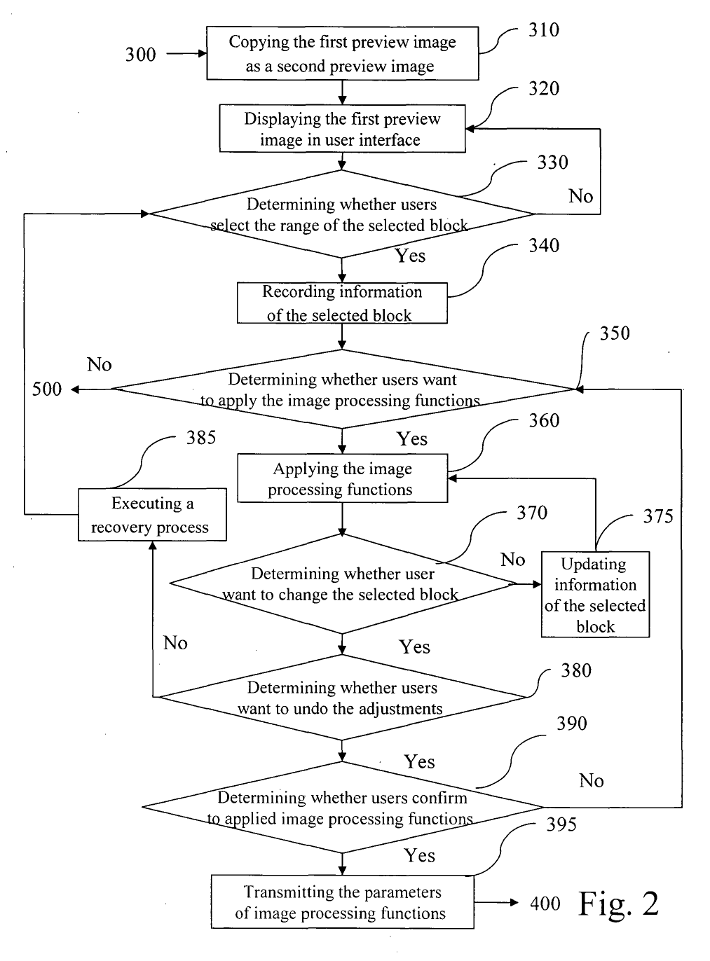

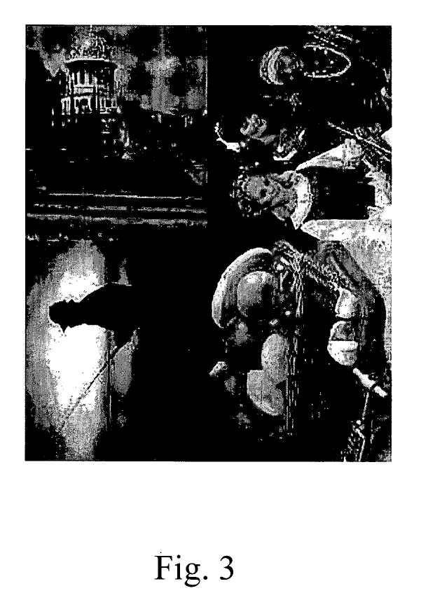

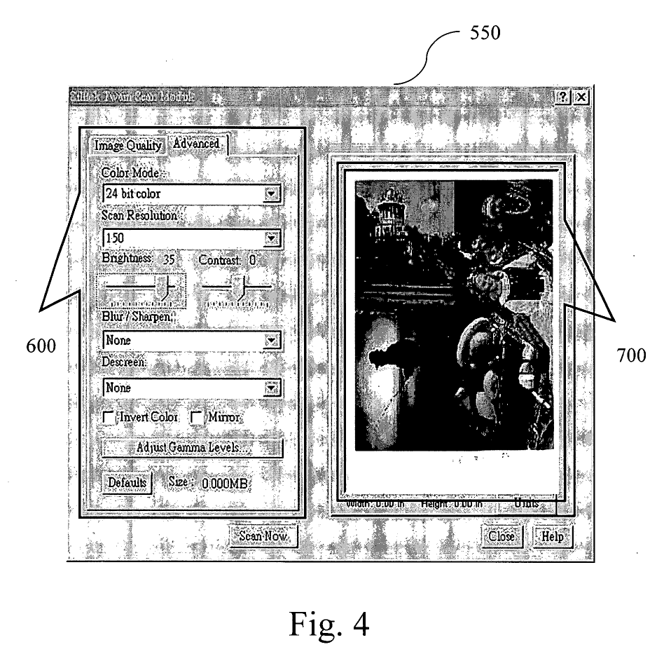

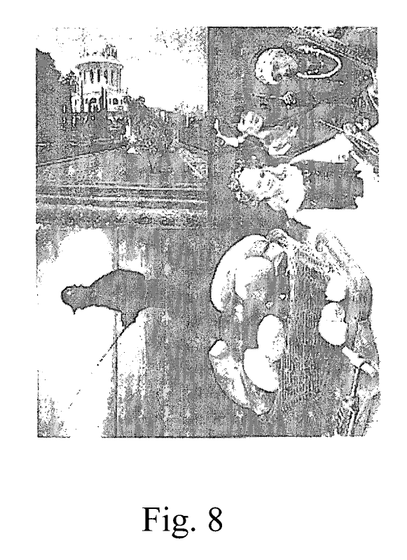

FIG. 1 shows the flowchart of the proposed method. The proposed method starts when users connect digital image input devices and computers and execute image-processing software. First, an original image is read. The image processing software reads the original image as shown in FIG. 3 from digital image input devices (Step 100). Then, a first preview image is extracted and previewed (Step 200). The image processing software extracts the first preview image according to the information of the original image and displays the preview image in the user interface of the image processing software (Please refer to FIG. 4). The users can select a block of the preview image and apply image-processing functions to the selected block (Step 300). The detailed flowchart is described by FIG. 2. Then, image-processing functions are applied on the original image (Step 400). That is, image-processing functions are applied to the original image, according to adjustment parameters (color mode adjustment, resolution adjustment, brightness adjustment contrast adjustment, sharpness/blur adjustment, special effects . . . ) specified by users on the preview image. Finally, the result image is displayed (Step 500). The image processing software displays the processed image as shown in FIG. 8 and the method terminates.

FIG. 2 shows a detailed flowchart of the image processing on the selected blocks. First, the first preview image is copied as the second preview image (Step 310). The second preview image is stored in the memory of the computers and can be used when the users want to undo the applied image processing functions. The first preview image is displayed in the user interface (Step 320). Then, the method determines whether the users select a block (Step 330). If not, the method returns to Step 320 to display the first preview image in the user interface. If so, the information of the selected block is recorded. The information comprises information of the original image (e.g., size, color . . . ), the coordination of the selected block, and the parameters of the applied image processing functions. After recording, the method determines whether users want to apply image-processing functions (e.g., color mode adjustment, resolution adjustment, brightness adjustment, contrast adjustment, sharpness/blur adjustment, special effects . . . ) (Step 350) on the selected block. If not, the method enters Step 500 since users want to display the original image. If so, the image processing functions are applied to the selected block (Step 360) and the processed image is displayed. In addition, the method determines whether users want to change the selected block (i.e., the position, the size and the range of the block) (Step 370)? If so, the information of the selected block is updated (Step 375) and the method returns to Step 360. Otherwise, the method determines whether users want to undo the adjustments (Step 380). If so, a recovery process is executed (Step 385). That is, the first preview image is replaced by the second preview image. After replacement, the method returns to Step 330 to enable users to re-select a block. If not, the method determines whether users confirm to apply the image processing functions (Step 390). If users confirm these functions, the parameters of image processing functions are transmitted to Step 400 to apply the image processing functions to the original image. Otherwise, the method enters Step 350 to enable users to execute other image processing functions. Note that image-processing functions are incremental. That is, multiple image processing functions can be applied to the same selected block at the same time.

The mentioned user interface (Please refer to FIG. 4) is provided by image processing software, and comprises the following two portions: image processing function setup area and image preview area. Users can set up the image processing functions to adjust the selected block in the image processing function setup area, and users can preview original and processing images in the image preview area.

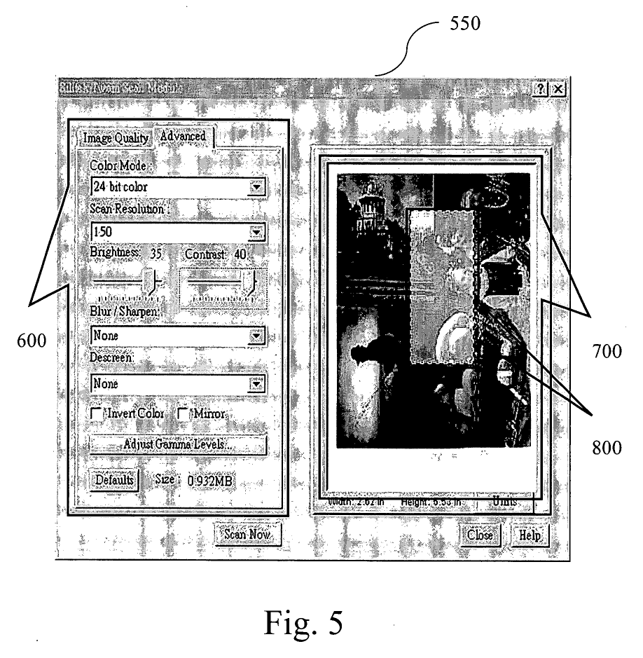

As shown in FIG. 5, 6, and 7, users can decide and change the size and coordinate of the selected block by mice in a drag and drop way.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A preview method of color processing on input images which enables users to select a block of a preview image in image processing software to apply various image processing functions in a WYSIWYG way, comprising the following steps:
reading an original image;
extracting and displaying a first preview image;
applying image processing functions on a selected block;
applying image processing functions on the original image; and
displaying the processed image.

2. The method of claim 1, wherein the original image is read by image processing software from a digital image input device.

3. The method of claim 2, wherein the digital image input device is one selected from the group consisting of a scanner, a digital camera and a digital video camcorder.

4. The method of claim 1, wherein the step of extracting the first preview image is executed in a user interface.

5. The method of claim 4, wherein the user interface comprises at least an image processing function setup area and an image preview area.

6. The method of claim 1, wherein the range of the selected block is determined by mice in a drag and drop way.

7. The method of claim 1, wherein the image processing functions comprise at least color mode adjustment, resolution adjustment, brightness adjustment, contrast adjustment, blur/sharpness adjustment and special effects.

8. The method of claim 1, wherein the information of the selected block comprises at least information of the original image, the coordinate of the selected block and the parameters of the applied image processing functions.

9. The method of claim 1, wherein information of the original image comprises at least the size and color of the image.

10. The method of claim 1, wherein the step of s applying image processing functions on the selected block further comprises steps of:
copying the first preview image to produce a second preview image;
displaying the first preview image in the user interface;
determining the rage of the selected block;
recording information of the selected block;
using the image processing functions;
applying the image processing functions of the selected block;
confirming to apply the image processing functions; and
transmitting the parameters of image processing functions.

11. The method of claim 10, wherein when users change the selected block further comprises steps of:
updating information of the selected block; and
applying the image processing functions of the selected block.

12. The method of claim 10, wherein when the users undo the applied image processing functions further comprises a step of a recovery process.

13. The method of claim 12, wherein the recovery process is to replace the first preview image by the second preview image.
